(19) United States
(12) Patent Application Publication
(10) Pub. No.: US 2011/0247703 A1
(43) Pub. Date: Oct. 13, 2011

(54) DIFFERENTIAL FLOW SIGNAL AMPLIFICATION

(76) Inventor: Geoffrey P. Brown, Vancouver (CA)

(21) Appl. No.: 12/898,269

(22) Filed: Oct. 5, 2010

Related U.S. Application Data
(60) Provisional application No. 61/248,497, filed on Oct. 5, 2009.

(51) Int. Cl. G05D 11/00

(52) U.S. Cl. 137/100

(57) ABSTRACT

A means to amplify the pressure effects of very small flows, or very small leaks, in contained fluid systems using pressure sensors in differential flow measurement devices. A ball valve in the passageway to the sensor static port achieves a small delay.

### CROSS REFERENCE TO RELATED APPLICATION

The present application claims the benefits, under 35 U.S.C. §119(e), of U.S. Provisional Application Ser. No. 61/248,497 filed Oct. 5, 2009 which is pending and is incorporated herein by this reference.

### TECHNICAL FIELD

The invention relates to the field of monitoring and measuring of fluid flows and more particularly methods of amplifying the effects of very small flows that occur in the supply pipe of contained fluid systems that have very small leaks.

### BACKGROUND

Various systems and methods of testing have been developed that shut a valve in the supply pipe to a contained fluid system and measure the decay of a signal detected by a pressure sensor over time, to determine the rate at which a system is leaking, or gas is flowing. This typically requires a full range pressure sensor to avoid over-pressurizing the sensor, and to allow moderate to larger flows to be more accurately detected, and this makes such systems inherently less sensitive.

Systems have also been developed using various flow amplification measurement methods. Such methods include using a Venturi with a differential, pressure sensor, or a smaller bypass pipe through which all flow is directed. These arrangements amplify the dynamic or velocity pressure signal by increasing the velocity of flow in the smaller diameter section. Since dynamic pressure, or equal drop in static pressure, varies as the square of velocity, the signal is amplified by the greater velocity in the contracted section, and the sensitivity increased. In the case of a Venturi, or any other differential flow measuring means, a more sensitive pressure sensor can be used, because it does not have to withstand the full static pressure range, but only the drop in static pressure, which is equal to the dynamic pressure caused by the flow.

The present method is applicable to flow measurement devices that use differential pressure sensors to detect pressure changes resulting from changed flow levels. As flow level increases, so does the dynamic, or velocity pressure, and Bernoulli's equation shows that the static pressure must fall to keep the sum of static pressure and dynamic pressure a constant. In differential sensors, there is usually a reduced section that amplifies the flow level in the pipe, reducing the static pressure still further in this reduced section. It is the difference between the two reduced levels of static pressure that constitutes the differential signal.

Suppose, by way of example, the differential flow measuring device uses a Venturi with a 50 percent by area contraction at the neck of the Venturi. Since Velocity×Area is also a constant for incompressible liquids and low pressure gas systems flowing in pipes, the flow velocity at the contraction is twice the velocity in the supply pipe. If the flow in the supply pipe is 1 ft./sec., the flow in the contraction will be 2 ft./sec., and since the dynamic pressure varies as the square of velocity, the dynamic pressure at the contraction of the Venturi is 4 times the dynamic pressure in the supply line. Consequently if the static pressure drop in the supply pipe is 1 unit of pressure, the static pressure drop at the contraction will be 4 units of pressure, to give a differential reading of 3 units of pressure.

In a flow measurement device capable of looking at instantaneous signals from pressure sensors, the immediate effect of any change in pressure from a change in flow level can be observed, processed and if required, stored in non-volatile memory for latter comparative use. The peak of such pressure signal occurs at approximately 100 msec. from valve actuation when the valve and measuring devices are separated by a few inches. Suppose that the static pressure port in the supply line had a small time delay of a few hundred msec. before coming to the reduced equilibrium pressure level caused by the flow that created a static pressure drop of 1 unit of pressure. At the 100 msec. time after valve activation the differential signal would now be closer to 4 units of pressure than 3, or a third larger than the signal would be without delaying the static port attaining equilibrium.

Suppose that the valve in the supply pipe to a contained fluid system is closed with the system pressurized at its normal working pressure. Such system might be a residential or commercial water system or gas system. Suppose a tap in a water system or an appliance in a gas system suddenly activated. If the flow measurement device was using static pressure sensors, it would have no trouble detecting the immediate drop in static pressure. However, if the flow measurement device uses differential pressure sensors to detect flow, even with the capability of tracking the instantaneous signal, the small 2 inch section of pipe between the supply pipe valve and the flow measuring device does not contain sufficient fluid to generate a readable signal at the flow measurement device, with the result the device would not know that the distribution system had been activated in some manner. However, if the static port of the differential sensor had a few hundred msec. delay in moving towards pressure equilibrium, which is atmospheric pressure in this case, the static pressure at the contraction of the Venturi would head immediately down, and the difference in this pressure and the delayed pressure at the static port would cause an immediate signal, allowing the flow measurement device using differential sensor means to recognize that flow has occurred and to open the supply pipe.

If the contained liquid system is a gas system of a residence or commercial building, and the system contains a pilot light, which would be the case if the building had a hot water heater, and the valve in the feeder pipe to such a gas system with a pilot light is closed for a small finite period of the order of 5 seconds, and then opened, the gas will flow into the piping system to replace the gas burnt through the pilot light while the valve was closed. There is no danger of extinguishing the pilot light, as dwellings typically have enough gas in the piping system to maintain the pilot light for in excess of 60 seconds. As discussed above, the peak of such pressure signal occurs at approximately 100 msec. from valve actuation when the valve and measuring devices are separated by a few inches, and any change in pressure from a change in flow level can be observed, processed and stored in non-volatile memory for latter comparative use by system or operator initiated test, or tests initiated by earthquake, or some other emergency triggering event.

Suppose however, while the supply pipe valve is closed, a furnace in the gas system activates. With the supply line valve closed, the gas system will be voided in as little time as one second, and the pilot light will be put out. To save the pilot light the flow measuring device must detect the sudden flow, abort the test and open the valve. As in the case above with no pilot light, a delay of a few hundred msec. in the static port moving towards equilibrium is sufficient for the flow measurement device to recognize that a flow has been activated, and to open the supply pipe valve, and postpone the test. This decision can typically be made within 20 msec., with the result that appliances, and operators of appliances, are unaware that the system was testing.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The invention provides a means of amplifying the signal from flow measurement devices using differential pressure sensors, by retarding the effect of static pressure changes at the static pressure port.

The invention further provides a means to amplify the pressure effects of very small flows, or very small leaks, in contained fluid systems using pressure sensors in differential flow measurement devices.

The present invention provides a means to amplify the pressure signals in differential flow measurement devices, from extremely small flows, by delaying the signal at the static port from quickly reaching equilibrium. The system comprises:

a) valve means for opening and closing the fluid supply line;
b) control means for controlling the valve means;
c) differential means for sensing a flow within the supply line comprising a differential pressure sensor;
d) means for processing data from sensing means;
e) means for storing data in the control means; and
f) means of delaying pressure equilibrium at the static port of the differential sensor.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a schematic of the embodiment used in the present invention.

FIG. 2 is a schematic of a typical pressure signal versus time after a valve is opened.

FIG. 3 is a schematic of a standard Venturi with a differential pressure sensor flow measurement device.

FIG. 4 is a schematic of the preferred static port flow delay means.

FIG. 5 is a detail of the preferred static port flow delay means shown in FIG. 4.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The present method and apparatus is useful in a METHOD AND SYSTEM FOR MONITORING GAS LEAKS BY AMPLIFICATION OF FLOW as disclosed in co-pending U.S. patent application Ser. No. 12/353,102 filed Jan. 13, 2009, which is incorporated herein by reference.

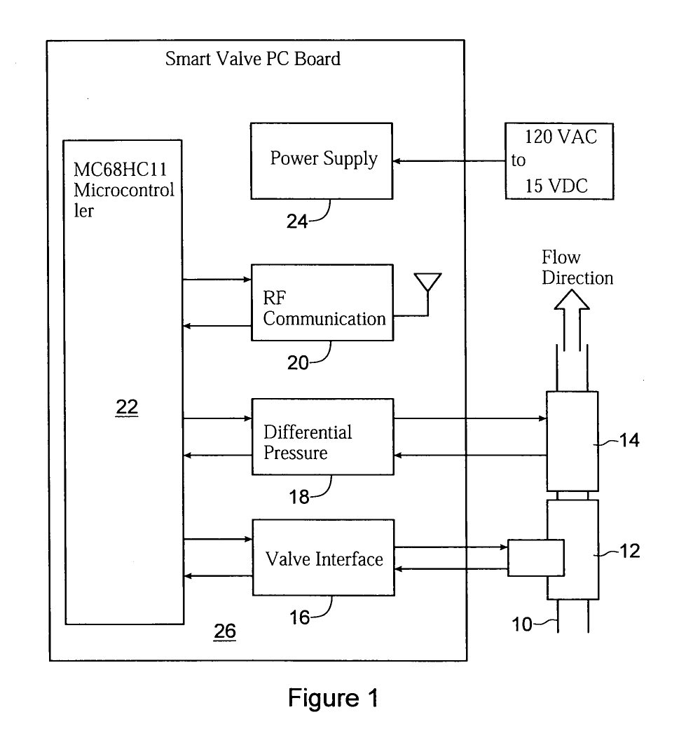

FIG. 1 shows a schematic diagram illustrating an embodiment of the system. A fluid supply line 10, such as a residential gas or water supply line, has a valve 12 and pressure sensor 14, which are controlled by a controller 22 mounted on printed circuit board 26. For example a MC68HC11 microcontroller manufactured by Motorola may be used. Valve 12 may be a solenoid valve manufactured by Fluid Control Division, Parker Hannifin. For a gas line, a Silicon Microstructures gas pressure transducer, model 5551 with an excitation of 1.50 mA @ 25 degrees C. may be used as the sensor 14. Table 1 illustrates the specifications for the Silicon Microstructures gas pressure transducer, model 5551. Microcontroller 22 activates valve 12 through interface 16 and the change in pressure measured by sensor 14, as described above, is communicated to the microcontroller 22 by differential pressure interface 18. Microcontroller 22 is powered by power supply 24. Microcontroller 22 monitors the differential pressure change through periodic monitoring as described above and if a leak situation is calculated, communicates an alarm through RF communication channel 20.

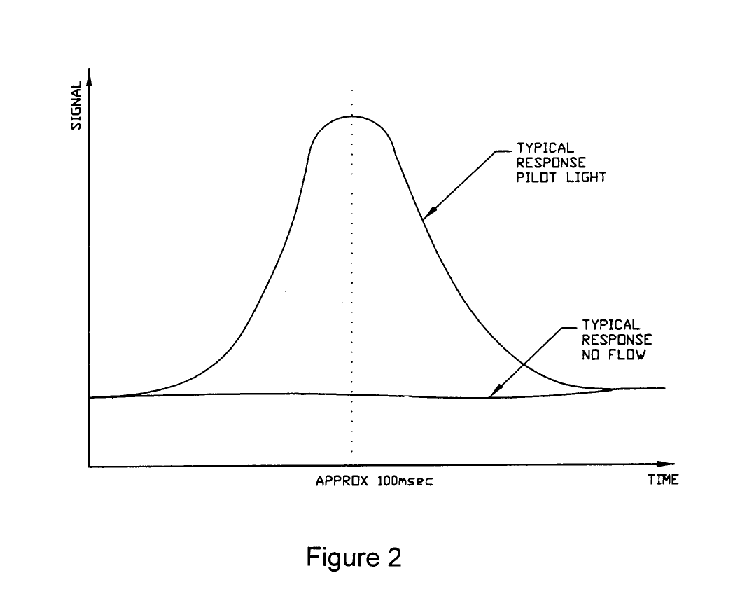

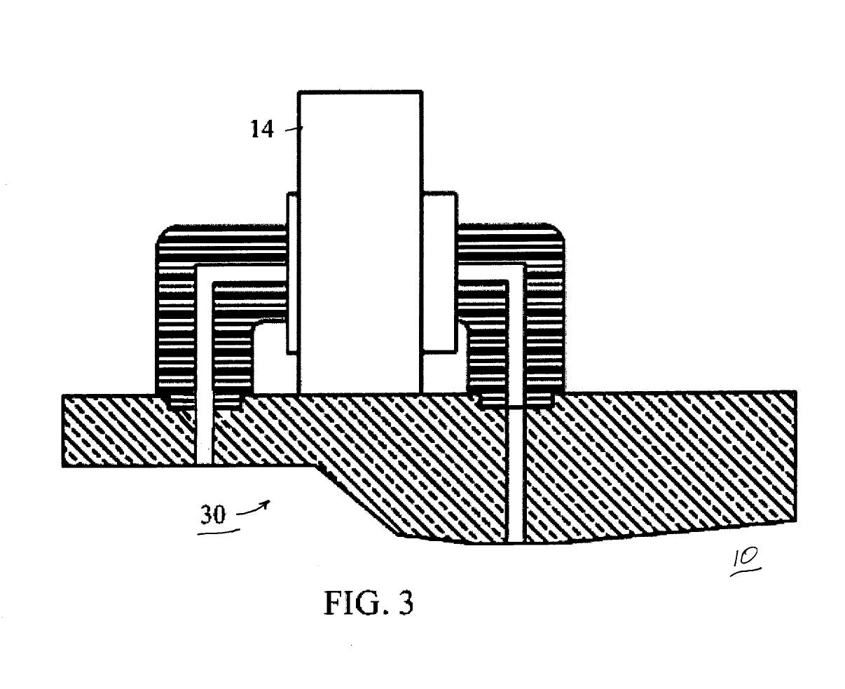

FIG. 2 illustrates the magnitude of a typical pressure transducer signal versus time after a valve is opened. FIG. 3 is a schematic of a standard prior art Venturi 30 with a differential pressure sensor flow measurement device 14 to measure the differential between the constricted section of the Venturi 30 and the supply pipe 10.

The present system provides means to amplify the pressure signals in differential flow measurement devices, from extremely small flows, by delaying the signal at the static port from quickly reaching equilibrium. The system comprises: a) valve means for opening and closing the fluid supply line; b) control means for controlling the valve means; c) differential means for sensing a flow within the supply line; d) means for processing data from sensing means; e) means for storing processed data in non-volatile memory in the control means; and f) means of delaying pressure equilibrium at the static port of a differential sensor. In one embodiment the means of delaying pressure equilibrium can be a reduced cross-sectional diameter of the external orifice of the static port of the differential pressure sensor, on the order of 2 or 3 thousandths of an inch in diameter.

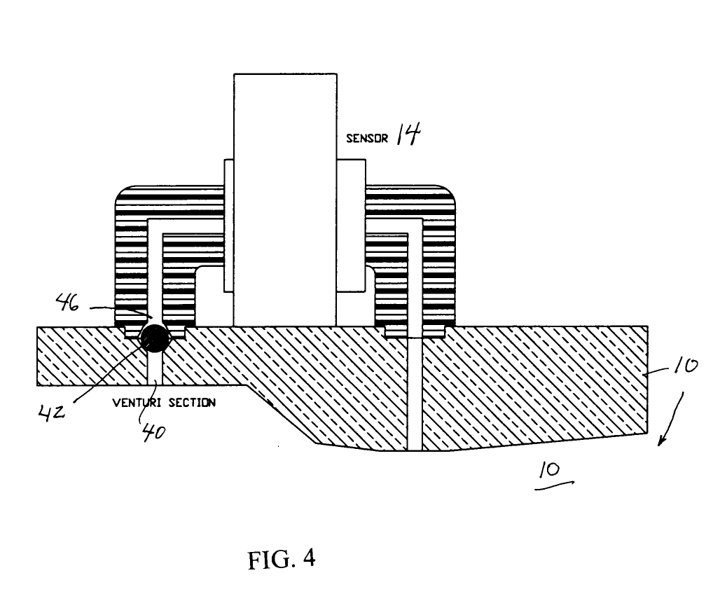

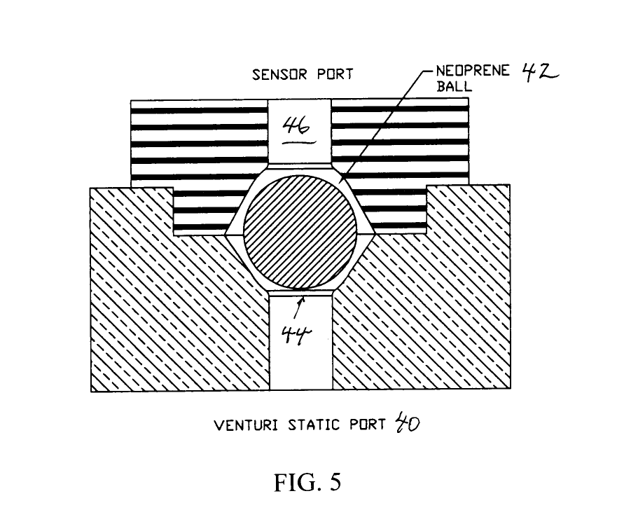

FIG. 4 is a schematic of a preferred means to delay by a few hundred milliseconds, preferably less than about 4 hundred milliseconds, the pressure at the sensor static port 46, from moving to its new level, as a result of changes in the flow level of the supply pipe 10. FIG. 5 is a detail schematic showing the sensor static port 46 with a small diameter neoprene ball 42 in a countersunk recess 44 at the external orifice 46 of the sensor port. When the pressure at Venturi port 40 is reduced in the supply pipe 10 by an increased level of flow, or due to a discharge downstream while the supply pipe valve 12 is closed, this ball 42 is pulled towards and seats in the recess 44, retarding flow and the release of pressure in the static port 46 of the differential pressure sensor 14. When the pressure in the supply pipe 10 increases due to a decrease in flow level in the supply pipe, or due to increased pressurization of a contained fluid system, the increasing pressure releases the ball 42 from the recess 44 and does not inhibit the pressure in the static port 46 from coming to equilibrium. There is insufficient flow and pressure change in the static port of low pressure systems, to lift the ball 42 and seat it for a rising pressure, but as with the constricted orifice embodiment, that has beneficial signal amplification effects.

While a number of exemplary aspects and embodiments have been discussed above, those of skill in the art will recognize certain modifications, permutations, additions and sub-combinations thereof. It is therefore intended that the invention be interpreted to include all such modifications, permutations, additions and sub-combinations as are within their true spirit and scope.

TABLE 1
Gas Pressure Transducer Specifications

| Parameter | Min | Typ | Max | Units |
|---|---|---|---|---|
| Excitation | 0.00 | 1.50 | 3.00 | mA |
| Output | | | | |
| Span | 25.00 | 50.00 | 75.00 | mV |
| Offset | −2.00 | ±0.20 | 2.00 | mV |
| Temperature | | | | |
| TC Span (0-70° C.) | −1.20 | ±0.20 | 1.20 | % FS/100° C. |
| TC Offset (0-70° C.) | −2.40 | ±0.20 | 2.40 | % FS/100° C. |
| Hysteresis | −0.30 | ±0.05 | 0.30 | % FS |
| Accuracy | | | | |
| Linearity | −0.15 | ±0.05 | 0.15 | % FS |
| Repeatability | −0.30 | ±0.05 | 0.30 | % FS |
| Pressure | −0.30 | ±0.05 | 0.30 | % FS |
| Hysterisis | | | | |
| Impedance | | | | |
| Z input | 2.20 | 3.00 | 3.80 | KΩ |
| Z output | 2.90 | 3.30 | 3.80 | KΩ |
| Temperature Range | | | | |
| Calibration | 0 | . . . | 70 | ° C. |
| Operating | −40 | . . . | 85 | ° C. |
| Dynamic | | | | |
| Characteristics | | | | |
| Proof Pressure | 3X | | | FS PSI (max) |
| Burst Pressure | 5X | | | FS PSI (max) |

Silicon Microstructures Model 5551 w/excitation = 1.50 mA @ 25° C.

The sensor driving electronics provides a constant 1.5 mA current.

Experimentation has shown that the SM sensor can reliably provide a signal resolution of 0.230 μV. Amplifying this signal to a value that can be seen by the 8-bit ADC (19.53 mV) requires the use of an 8-bit bit DAC in the windowing system. Production systems will, most likely, not be able to reliably produce the 0.230 μV signal. Because of these factors, the signal resolution will be specified at 0.390 μV.

What is claimed is:

1. Apparatus for amplifying the pressure signals from extremely small flows in a fluid supply line having a differential flow measurement device comprising a differential pressure sensor having a static port, by delaying the signal at the static port from reaching equilibrium, said apparatus comprising:
a) valve means for opening and closing the fluid supply line;
b) control means for controlling the valve means;
c) differential means for sensing a flow within the supply line comprising a differential pressure sensor having a static port;
d) means for processing data from said differential sensing means;
e) means for storing processed data in memory in the control means; and
f) means of delaying pressure equilibrium at the static port of said differential sensor.

2. The apparatus of claim 1 wherein said means of delaying pressure equilibrium at the static port of said differential sensor comprises a ball valve in the passageway from the sensor static port whereby when pressure in the supply line increases the ball of said ball valve is pulled towards and seats in a recess thereby retarding flow and the release of pressure in the static port of the differential pressure sensor, and when the pressure in the supply line increases due to a decrease in flow level in the supply line the increasing pressure releases the ball from the recess.

3. The apparatus of claim 1 wherein said retarding of static pressure changes is less than about 4 hundred milliseconds

4. A method of amplifying the signal from flow measurement devices using differential pressure sensors in the supply line of contained fluid systems that have very small leaks, wherein said supply line is provided with a valve and a pressure sensor, the method comprising retarding the effect of static pressure changes at the static pressure port of said differential pressure sensor.

5. The method of claim 4 wherein said retarding of static pressure changes at the static pressure port is achieved by providing a ball valve in the passageway from the sensor port whereby when pressure in the supply line increases the ball of said ball valve is pulled towards and seats in a recess thereby retarding flow and the release of pressure in the static port of the differential pressure sensor, and when the pressure in the supply line increases due to a decrease in flow level in the supply line the increasing pressure releases the ball from the recess.

6. The method of claim 4 wherein said retarding of static pressure changes is less than about 4 hundred milliseconds.
